(19) United States
(12) Patent Application Publication
(10) Pub. No.: US 2007/0040444 A1
(43) Pub. Date: Feb. 22, 2007

(54) Spoke for bicycle and motorcycle wheels

(76) Inventor: Moreno Fioravanti, Lomagna LC (IT)

Correspondence Address: RATNERPRESTIA, P O BOX 980, VALLEY FORGE, PA, 19482-0980, US

(21) Appl. No.: 10/556,192

(22) PCT Filed: May 10, 2004
(86) PCT No.: PCT/IT04/00255

§ 371 Date: Nov. 10, 2005

(30) Foreign Application Priority Data
May 13, 2003 (IT) BO2003A000291

(51) Int. Cl. B60B 1/00

(52) U.S. Cl. 301/104

(57) ABSTRACT

A spoke for the wheels of bicycles and motorcycles including an elongated central portion, an opposing first terminal portion and a second terminal portion suitable for attachment to the rim and hub of the wheel respectively, and at least one longitudinal cavity extending substantially from the first terminal portion to the second terminal portion.

### TECHNICAL SCOPE

This invention relates to a spoke for bicycle and motorcycle wheels.

### TECHNICAL BACKGROUND

Bicycles and motorcycles, with particular reference to racing bicycles and mountain bicycles, are these days subjected to ever-increasing stresses requiring forms of manufacture which offer high performance and are highly reliable.

The wheels of such bicycles must have high strength, rigidity and lightness, together with marked aerodynamic characteristics and ever-changing and innovative aesthetic qualities to meet the technical requirements of users. Spokes in particular are typically subjected to enormous dynamic loads when In use, which inevitably mean that the transverse cross-section must be overdimensioned at the design and testing stage, or that materials of excessive weight must be used. These options therefore give rise to wheels whose operating performance is not capable of satisfying the abovementioned needs.

### DESCRIPTION OF THE INVENTION

The technical purpose of this invention is to overcome the abovementioned deficiencies, providing a spoke for bicycle and motorcycle wheels which features high-grade mechanical and aerodynamic properties, together with an extremely small weight.

Within the scope of this technical purpose one object of this invention is to provide a spoke having optimum performance and characteristics which can be manufactured using conventional means and methods of production.

A further object of this invention is to fulfil the abovementioned purpose through a simple structure which is relatively simple to implement in practice, safe in use and effective in operation, and of relatively low cost.

This purpose and these objects are achieved through this spoke for bicycles and motorcycles wheels comprising an elongated central portion, an opposing first terminal portion and a second terminal portion appropriate for attachment to the rim and the hub of the wheel respectively, characterised in that it has at least one longitudinal cavity substantially extending from the said first terminal portion to the said second terminal portion.

### BRIEF DESCRIPTION OF THE DRAWINGS

Other advantages and characteristics of the present invention will,become clear from the following detailed description which is given with reference to the appended drawings which are provided purely by way of non-limiting example and in which:

FIG. 1 illustrates a view in lateral elevation and partial cross-section of a spoke according to the invention,

FIG. 2 shows a view in lateral elevation and partial cross-section of a first alternative embodiment of the spoke,

FIGS. 2a, 2b, 2c, 2d, 2e show views In plan of corresponding embodiments of the spoke in FIG. 2,

FIG. 3 illustrates a view in lateral elevation and partial cross-section of a second alternative embodiment of the spoke according to the invention,

FIG. 4 shows a plan view of the spoke in FIG. 3,

FIGS. 4a, 4b, 4c, 4d, 4e show plan views of corresponding embodiments of the spoke in FIG. 3,

FIG. 5 shows a view in lateral elevation of a third alternative embodiment of the spoke according to the invention,

FIG. 6 shows a view in lateral elevation of a detail of the spoke in FIG. 5 in partial cross-section,

FIG. 7 shows a transverse cross-section of the central portion of the same spoke along the plane VII-VII in FIG. 5.

### PREFERRED MANNER OF IMPLEMENTING OF THE INVENTION

In the embodiments which follow individual features relating to specific examples may in fact be Interchanged with other features present in other embodiments.

Also it should be noted that everything which proves to be already known in the course of the procedure for obtaining the patent is not intended to be claimed and is removed from the claims.

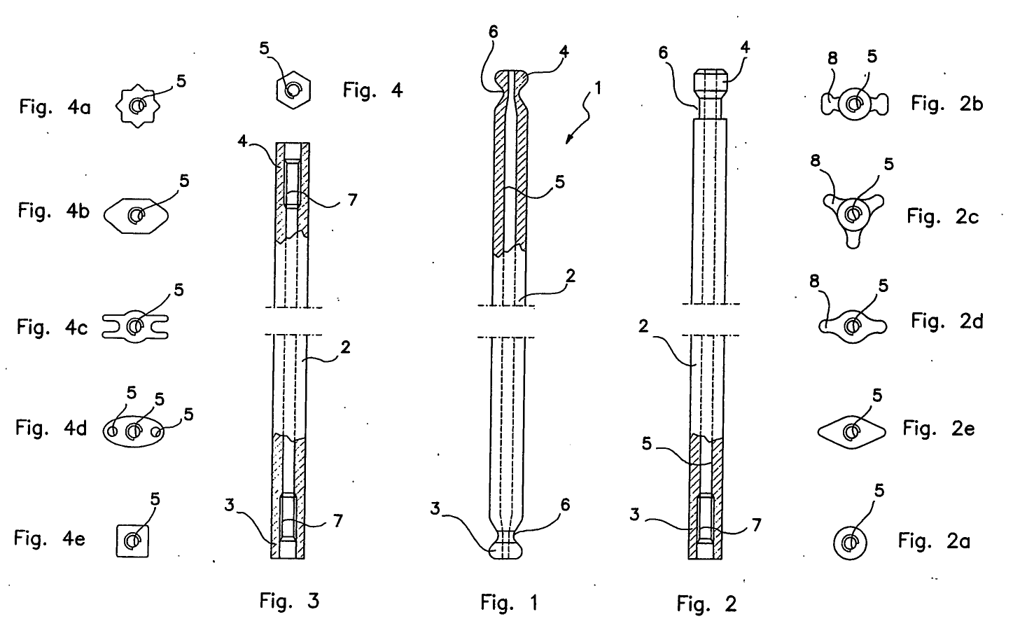

With particular reference to FIG. 1, 1 indicates as a whole a spoke for the wheels of bicycles and motorcycles according to the invention.

The spoke is preferably manufactured of light metal alloy selected on the basis of strength, rigidity, lightness, cost and workability requirements. Aluminium alloys, titanium, brass, copper or even steel may for example be used.

The spoke comprises, in a known way, an elongated central portion 2 of substantially circular cross-section (or any other shape), and opposing first terminal portion 3 and second terminal portion 4. First terminal portion 3 is suitable for attachment to the rim of the wheel, preferably through a threaded nipple or other equivalent means; second terminal portion 4 on the other hand is suitable for rigid attachment of the spoke to the hub of the wheel, for example through engaging in a corresponding hole as a result of being appropriately shaped.

According to the invention the spoke has at least one elongated longitudinal cavity 5 which extends substantially from first terminal portion 3 to second terminal portion 4. This cavity 5 makes it possible in the first place to achieve a substantial decrease in the weight of the spoke, in a manner which is wholly obvious; secondly, furthermore, the transverse cross-section of the spoke so defined is distinguished by a higher modulus of resistance to the operating stresses to which the wheel is subjected.

Cavity 5, preferably of circular transverse cross-section, is substantially coaxial with central portion 2 of the spoke, and is constructed so as to pass from first terminal portion 3 to second terminal portion 4, at which it forms corresponding circular orifices.

First terminal portion 3 and second terminal portion 4 are substantially mushroom-shaped defining corresponding annular grooves 6 so that they can be anchored to the rim and hub of the wheel respectively. Correspondingly longitudinal cavity 5 narrows in relation to annular grooves 6.

The spoke according to the invention may be manufactured using various conventional manufacturing technologies. Preferably drawn or extruded tubes are used, which are then tapered or formed using appropriate moulds. As an alternative, forgings or metal which has been cut and folded back on itself or rolled may be used.

Another particularly indicated manufacturing technology is that of melting under pressure, or lost wax melting, in a shell mould or in sand.

This is how the invention achieves the stated objectives.

Through-cavity 5 provided in the spoke makes it possible to substantially reduce its overall weight, at the same time obtaining an increase in the mechanical properties of strength and rigidity, and optimising aerodynamic behaviour when in use. In addition to this it is possible to produce spokes of complex shape and geometry so as to respond effectively to users always changing technical and aesthetic requirements.

The invention conceived in, this way is susceptible of many modifications and variants all of which fall within the scope of the inventive concept.

FIG. 2 illustrates a first alternative embodiment of the spoke according to the invention. This has second terminal portion 4 shaped substantially in the form of a mushroom defining an annular groove 6 for anchoring to the hub of the wheel, while first terminal portion 3 has a uniform cross-section. Longitudinal cavity 5 has a threaded portion 7 of suitable axial length corresponding to first terminal portion 3, such as to define a female thread for securing to the rim of the wheel. It will be noted that in the same way (in relation to the characteristics of the wheel within which the spoke Is assembled) a first substantially mushroom-shaped terminal portion 3 may be provided for attachment to the rim, and a second terminal portion 4 of uniform cross-section corresponding to which longitudinal cavity 5 has a threaded section 7, which is suitable for attachment to the hub, may be provided respectively.

FIGS. 2a-2e illustrate plan views of corresponding embodiments of the spoke in FIG. 2 which differ from each other in the geometry of the cross-section in relation to requirements for strength, rigidity and aerodynamic properties. In particular the example in FIG. 2a relates to a spoke of circular transverse cross-section, while that in FIG. 2e is rhomboidal; examples 2b, 2c, 2d illustrate spokes having a complex central portion 2 comprising a substantially cylindrical core with lateral ribs 8 of various shapes and dimensions.

In a second alternative embodiment of the spoke according to the invention, illustrated in FIG. 3, first terminal portion 3 and second terminal portion 4 both have substantially uniform cross-sections, for example of regular hexagonal shape (FIG. 4); corresponding to the latter the through longitudinal cavity defines threaded lengths 7 for attachment to the rim and the hub of the wheel respectively.

Further embodiments of the spoke in FIG. 3 are illustrated in plan in FIGS. 4a-4e; these embodiments differ from each other in the geometry of the cross-section of the central portion 2 and terminal portions 3, 4 on the basis of specific strength and aerodynamicity requirements (substantially star-shaped cross-section in FIG. 4a, lozenge-shaped in FIG. 4b, double fork in FIG. 4c, elliptical with three cavities 5 In FIG. 4d, square in FIG. 4e). The geometry of the transverse cross-section of the spokes in FIGS. 1, 2, 3 may in fact be of any kind designed on the basis of considerations of a technical and aesthetic nature.

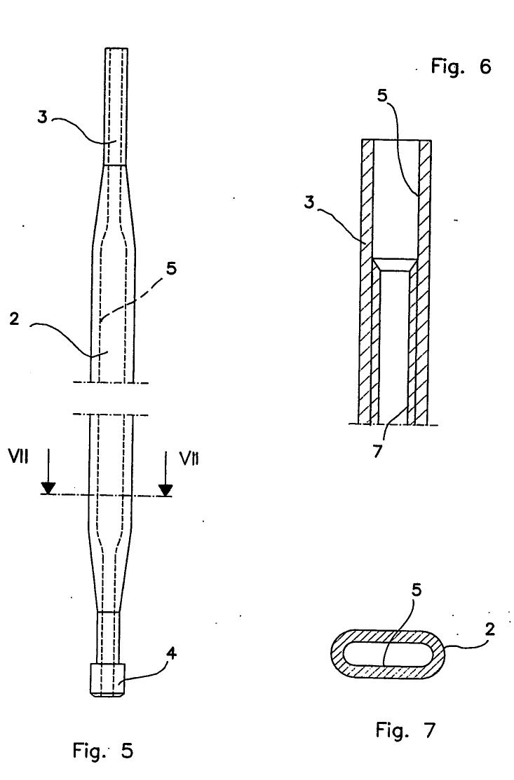

FIG. 5 relates to a third alternative embodiment of the spoke according to the Invention. The latter is distinguished by a central portion 2 of substantially elliptical cross-section (FIG. 7) which tapers at first and second terminal portions 3, 4. First terminal portion 3 has a uniform circular cross-section, while second terminal portion 4 is substantially mushroom-shaped.

Along central portion 2 longitudinal through cavity 5 has a substantially flattened elliptical cross-section and has a threaded portion 7 for attachment to the rim of the wheel (which can be seen in the detail in FIG. 6) at terminal portion 3. The elliptical cross-section makes it possible to achieve high mechanical strength and optimum aerodynamic properties for the wheel.

All the details may be replaced by others which are technically equivalent.

In practice the materials used, as well as shapes and dimensions, may be of any kind in relation to requirements without thereby going beyond the scope of protection of the following claims.

1. A spoke for bicycle and motorcycle wheels comprising: an elongated central portion, an opposing first terminal portion and a second terminal portion suitable for attachment to a rim and hub of the wheel respectively, and at least one longitudinal cavity extending substantially from the first terminal portion to the second terminal portion.

2. The spoke according to claim 1, wherein the longitudinal cavity is substantially axial and passes from the first terminal portion to the second terminal portion.

3. The spoke according to claims 1 wherein the cavity has a first threaded portion corresponding to the first terminal portion for attachment to the rim.

4. The spoke according to claim 1 wherein the cavity has a second threaded portion corresponding to the second terminal portion for attachment to the hub.

5. The spoke according to claim 1 wherein the first terminal portion is substantially mushroom-shaped.

6. The spoke according to claim 1 wherein the second terminal portion is substantially mushroom-shaped.

7. The spoke according to claim 1 wherein the cavity has a substantially circular cross-section.

8. The spoke according to claim 1 wherein the cavity has a substantially elliptical cross-section.

9. The spoke according to claim 1 wherein it is constructed of light metal alloy.

10. (canceled)

11. The spoke according to claim 2 wherein the cavity has a first threaded portion corresponding to the first terminal portion for attachment to the rim.

12. The spoke according to claim 2 wherein the cavity has a second threaded portion corresponding to the second terminal portion for attachment to the hub.

13. The spoke according to claim 3 wherein the cavity has a second threaded portion corresponding to the second terminal portion for attachment to the hub.

14. The spoke according to claim 2 wherein the first terminal portion is substantially mushroom-shaped.

15. The spoke according to claim 3 wherein the first terminal portion is substantially mushroom-shaped.

16. The spoke according to claim 4 wherein the first terminal portion is substantially mushroom-shaped.

17. The spoke according to claim 2 wherein the second terminal portion is substantially mushroom-shaped.

18. The spoke according to claim 3 wherein the second terminal portion is substantially mushroom-shaped.

19. The spoke according to claim 4 wherein the second terminal portion is substantially mushroom-shaped.

20. The spoke according to claim 5 wherein the second terminal portion is substantially mushroom-shaped.
